(19) United States
(12) Patent Application Publication
(10) Pub. No.: US 2026/0058282 A1
(43) Pub. Date: Feb. 26, 2026

(54) Battery With Particle Protection and Motor Vehicle Equipped Therewith

(71) Applicant: Bayerische Motoren Werke Aktiengesellschaft, Muenchen (DE)

(72) Inventors: Martin KORN, Jetzendorf (DE); Friedemann MOELLER, Muenchen (DE); Robin RUECKER, Schaeftlarn (DE)

(21) Appl. No.: 19/103,873

(22) PCT Filed: Aug. 28, 2023
(86) PCT No.: PCT/EP2023/073478

§ 371 Date: Feb. 14, 2025

(30) Foreign Application Priority Data
Sep. 26, 2022 (DE) 102022124607.8

(51) Int. Cl. H01M 50/249; B60L 50/64; H01M 10/613; H01M 10/625; H01M 50/204; H01M 50/222; H01M 50/224; H01M 50/24

(52) U.S. Cl. CPC H01M 50/249; H01M 10/613; H01M 10/625; H01M 50/204; H01M 50/222; H01M 50/224; H01M 50/24; B60L 50/64; H01M 2220/20

(57) ABSTRACT

A battery and a motor vehicle equipped therewith has a battery housing in which several separate receiving compartments are formed by the housing walls of the housing and by load-bearing struts extending between the housing walls. Several cell modules are arranged in each of these receiving compartments. Between two cell modules arranged adjacently in one of the receiving compartments, a non-load-bearing protective plate is arranged in each case to contain, in regions, a spreading of a battery leakage from one of the adjacent cell modules to the other. This protective plate differs from the battery housing and from a structure of the receiving compartments.

### BACKGROUND AND SUMMARY

The present invention relates to a battery which can be designed in particular as a traction battery for a motor vehicle. The invention further relates to a motor vehicle with such a battery.

Nowadays, batteries are used in many different technical fields and applications. The operational safety of batteries is an important factor in their design and construction, not least because increasingly higher demands are being placed on batteries, for example with regard to the highest possible energy density and capacity as well as relatively high charging and discharging capacities. In order to ensure the safety of a battery, for example a high-voltage traction battery of a motor vehicle or similar, even in the event of an accident or fire, a significant amount of effort is put into conventional batteries, but this can be associated with correspondingly high costs, high installation space requirements and high weight.

In particular, a defect in a battery cell can lead to thermal propagation and thus to a thermal runaway of several battery cells. Hot gases and electrically conductive particles can be emitted from correspondingly thermally runaway battery cells, which can lead to damage or bridging of the intended insulating air gaps or creepage distances at critical points within the battery. In today's high-voltage batteries, massive fire protection walls or struts are therefore often provided to improve safety. However, these can adversely lead to or contribute to a reduced energy density of the battery as a whole and to an undesirably high weight of the batteries. For this reason, not every battery cell or cell module comprising several battery cells is often fully encapsulated accordingly. However, if one or more battery cells in a cell module then undergo thermal runaway, this can lead to electrically conductive particles flying unhindered onto an adjacent cell module, settling there and, at least after a certain time, violating the intended air and creepage distances. Depending on the voltage level, this can lead to arcing or short circuits, for example, which can further intensify the propagation behavior within the battery.

For example, EP 2 506 336 A1 describes a thermal management system for a battery pack. A multi-sided, airtight battery pack housing for accommodating several batteries is provided therein. A side part of the battery pack housing includes a cavity, and an inner housing wall thereof includes several through-holes for passing gas from the interior of the battery pack housing to the cavity. Furthermore, a gas outlet opening integrated in an outer wall of the battery pack housing is provided, which is in gas exchange with the cavity. This gas outlet opening is sealed with a cap arrangement that has a one-way valve. However, even with this arrangement, the interior of the battery pack can be divided into several sections by cross struts so that the spread of thermal events from one section to the next can be inhibited, but several cell modules can be arranged in each section.

DE 10 2020 128 756 A1 describes a battery with a battery housing and several battery cells arranged therein as a further approach to limiting consequential damage from thermal runaway of a battery cell. The battery cells each have an electrical contact and a degassing point on one side. An electrically insulating flat protective element is arranged between an outer wall of the battery housing, to which the degassing points face, and the battery cells, so that it covers the degassing points and the electrical contacts. The protective element is thermally resistant over a large part of its surface and has predetermined breaking points at the degassing points, which can be broken through by the material escaping from the respective battery cell in the event of a thermal fault.

The object of the present invention is to provide a safe and space-efficient battery.

This problem is solved by the subjects of the independent claims. Further possible embodiments of the invention are disclosed in the dependent claims, the description and the figures. Features, advantages and possible embodiments which are set out in the description for one of the subjects of the independent claims are to be regarded at least analogously as features, advantages and possible embodiments of the respective subjects of the other independent claims and of any possible combination of the subjects of the independent claims, possibly in conjunction with one or more of the dependent claims.

In particular, the battery according to the invention can be designed as a traction battery for a motor vehicle. However, the battery according to the invention can also be, for example, a domestic battery or a buffer or stabilizing battery for a power grid or the like. The battery according to the invention has a battery housing in which several separate storage compartments are formed by its housing walls, for example by a housing base, a housing cover and outer or side walls of the battery housing, and several load-bearing struts extending from one housing wall of the battery housing to an opposite housing wall of the battery housing. In particular, the several struts can run parallel to each other.

The struts can, for example, be cross struts or structural or stiffening elements designed as fire protection walls or similar.

The battery housing can therefore have compartments or compact elements that are at least substantially separated from each other or sealed off from each other. Between these, for example, only a feedthrough for cabling and/or a coolant line or the like can be provided. The load-bearing struts can thus contain or prevent the spread of ejection, such as of heated gas and/or particles, from a battery cell arranged in a receiving compartment to a battery cell arranged in an adjacent receiving compartment. At the same time, the struts can be designed and arranged to absorb or transmit mechanical loads acting on the battery housing from the outside, for example in the event of an accident involving the corresponding motor vehicle.

In the battery according to the invention, several, in particular at least or exactly two, cell modules are arranged in some or all of the receiving compartments. These cell modules can each comprise several electrically interconnected individual battery cells. In addition, the cell modules can each have their own module housing for accommodating the respective battery cells.

According to the invention, a non-load-bearing protective plate is arranged in each case between two cell modules arranged adjacently to one another in one of the receiving compartments, in particular when viewed in the main plane of extent of the struts. This protective plate can therefore be arranged between mutually facing side walls of adjacent cell modules or corresponding module housings arranged in a receiving compartment. The respective protective plate is arranged and designed here to contain, in regions, the spread of a cell ejection, in particular of heated and/or electrically conductive particles, in the event of a thermal runaway of a battery cell of one of the two adjacent cell modules to the other of the two adjacent cell modules.

The protective plate or protective plates of the battery according to the invention can therefore be made of a heat-resistant material. For example, such a protective plate can be designed to withstand a temperature load of several 100° C. or 1000° C. or more or exposure to correspondingly heated particles from a thermally runaway battery cell for several minutes.

The containment, in regions, of such a cell ejection can mean here in particular that the respective protective plate does not completely or fully seal off the two adjacent cell modules from each other. The protective plate therefore does not divide the receiving compartment into two receiving compartments. Accordingly, the respective protective plate according to the invention is different from the battery housing and a structure of the receiving compartments, i.e., in particular also from the load-bearing struts.

The at least one protective plate provided in the battery according to the invention is therefore not designed as a structure-supporting or structure-forming component of the battery or the battery housing, i.e., not as a mechanically stabilizing component. Likewise, the respective protective plate is not part of a compartment structure of the battery housing formed by the housing walls and the struts. In particular, it may be provided that the respective protective plate is not designed, configured and arranged to absorb or transmit mechanical loads or forces acting on the battery housing from the outside, i.e., it is not integrated with the load-bearing struts, for example.

The proposed design of the protective plate according to the invention allows it to be particularly small, light and space-saving and at the same time optimized with regard to its function of inhibiting cell ejection. In addition, the protective plate can be arranged here in a targeted manner, i.e., particularly precisely or for optimized inhibition of cell ejection, for example in a most probable propagation path of such a cell ejection between the adjacent cell modules and/or, in particular, only cover components that are particularly susceptible to damage or short-circuits. This is possible here in a particularly simple, selective and detailed manner and is therefore both effective and space-saving, i.e., particularly efficient overall, as the respective protective plate does not also have to be load-bearing, i.e., does not have to be mechanically stable. As a result, the protective plate can, for example, be flexibly arranged or adapted to an arrangement or contour of other components. The protective plate can therefore have bends and/or recesses and/or regions with reduced material thickness and/or the like. The protective plate can thus follow a corresponding contour of surrounding components and/or can also utilize irregularly shaped free spaces between the two adjacent cell modules. This therefore allows the protective plate to be arranged while effectively utilizing any existing cavities or spaces between the adjacent cell modules and/or battery components arranged there.

Thus, the present invention enables an effectively improved safety or an improved limitation of consequential damage in the event of a thermal runaway of a battery cell of the battery while at the same time not increasing or only minimally increasing the installation space requirement and weight of the battery as a whole. For example, the protective plate can be used to reduce safety margins or designs for clearance or creepage distances and/or electrical and/or thermal insulation of components now protected by the protective plate.

The term “protective plate” is to be understood here only as an indication of a possible rough shape of the corresponding component. The protective plate according to the invention therefore does not actually have to be strictly plate-shaped.

In a possible embodiment of the present invention, the respective protective plate is arranged or oriented in such a way that its main direction of extent or main plane of extent is perpendicular to the main direction of extent of the adjacent struts, i.e., the struts laterally delimiting the respective receiving compartment. The combination of the struts and the protective plate thus enables a stable, robust and safe design of the battery in a particularly simple and space-saving manner, while at the same time saving installation space. This can apply, for example, in comparison to a structure made up of intersecting struts, in which only a single cell module would be arranged in each compartment surrounded by struts. The struts can therefore be cross struts in relation to the entire battery or battery housing, for example, while the protective plate or plates can then be arranged in the longitudinal direction.

In a further possible embodiment of the present invention, the respective protective plate is made of sheet steel or a mica material. Such a mica material can be pure mica, i.e., a mineral material from the mica group, or can comprise such a material. The design of the protective plate proposed here enables a particularly good protective effect with simultaneously particularly low installation space requirements, i.e., particularly low material thickness, and correspondingly low weight of the protective plate. This means that the safety or robustness of the battery can be improved or achieved particularly efficiently.

In a further possible embodiment of the present invention, the respective protective plate is spaced at least in or along its main direction of extent from the adjacent struts, i.e., the struts laterally delimiting the respective receiving compartment. There may thus be a distance or gap between the respective strut and the side edge of the protective plate facing it, as viewed in or along the main direction of extent of the protective plate. In other words, it may be provided that the protective plate does not extend all around or at least in its main direction of extent as far as the struts and/or housing walls delimiting the respective receiving compartment. Thus, the protective plate can, for example, leave open there a deformation space or a connection to a deformation space within the battery housing.

Such a deformation space can provide space for deformation, i.e., deformation of the outer housing walls of the battery housing, in the event of a mechanical force or load acting on the battery housing from the outside, in order to prevent the cell modules from being subjected to a corresponding force.

The distance between the protective plate and the struts and/or housing walls provided here can also limit a pressure increase in the region of the respective cell module in which a battery cell thermally leaks, for example in comparison to the completely sealed individual encapsulation of all cell modules. This can also contribute to limiting consequential damage caused by thermal runaway of a battery cell. At the same time, the distance provided here can be negligible from a safety point of view, because the probability of cell ejection passing through and subsequently landing on the respective adjacent cell module or its safety-relevant electrical components or at other critical points can be relatively small-for example in comparison to the probability of the cell ejection being intercepted or stopped by the protective plate.

Furthermore, the spacing provided here next to the protective plate can make it particularly easy to insert the protective plate and/or the cell modules into the receiving compartment or the battery housing and thus enable particularly simple production or final assembly of the battery. Furthermore, the spacing provided here can ensure that a direct introduction of force into the protective plate is avoided or minimized even in the event of a mechanical load acting on the battery housing from the outside. This can reduce the risk of the protective plate being damaged or displaced in such a case. As a result, the protective plate can fulfill its thermal and material-inhibiting protective function particularly reliably and safely even in such a load case.

In a further possible embodiment of the present invention, the respective protective plate in its main plane of extent, i.e., the directions or dimensions spanning this main plane of extent, is at most as large as, in particular smaller than, the side walls facing it of the respective two adjacent cell modules or the module housings of these cell modules. In other words, the protective plate does not protrude beyond the cell modules in the directions of its main plane of extent. As a result, the protective effect can be achieved by the protective plate without requiring additional installation space of the battery in the directions spanning the main plane of extent of the protective plate and without, for example, obstructing a contacting of the cell modules and/or a cable routing or a routing or arrangement of coolant lines or the like within the battery or within the respective receiving compartment. This means that the protective plate provided according to the invention can also be integrated into existing battery designs in a particularly simple and space-efficient manner.

In a further possible embodiment of the present invention, the respective protective plate is fastened to a steel joining part by means of a snap connection-also known as a clip connection. Such a snap connection can enable particularly simple fastening of the protective plate by elastic deformation and hooking of the joining part in or with a corresponding counterpart. Such a snap connection can, for example, enable particularly simple manufacture or final assembly of the battery, for example in comparison to a screw connection or welding of the protective plate. The steel design of the deformable joining part of the snap connection can ensure a particularly high temperature stability of the snap connection. This means that even in the event of a thermal fault in one of the battery cells of the adjacent cell modules, the snap connection can hold the protective plate in its intended installation location. This can be seen, for example, in comparison to a plastics-based fastening of the protective plate.

In a further possible embodiment of the present invention, the adjacent cell modules each comprise several battery cells and end pressure plates clamping them. In this case, the protective plate is attached on the outside, i.e., on or to an outer side of such a pressure plate facing the respective other cell module and facing away from the battery cells of the respective cell module, of only one of the two cell modules. Since such pressure plates must naturally be designed to be stable in order to fulfill their primary task of stably clamping the battery cells, they can also provide a correspondingly stable holding or fastening option for the protective plate without further adjustments. This means that the protective plate can be fastened in a particularly secure and low-cost manner, for example without the need for an additional holding structure. In addition, the protective plate can be fastened or arranged in a particularly space-saving manner, since, for example, no tolerance needs to be planned for a separate insertion of the cell modules and the protective plate into the battery housing or the respective compartment. In particular, by attaching the protective plate to one of the cell modules, a corresponding composite of cell module and protective plate can be prefabricated separately, i.e., outside the battery, and then handled particularly easily during production or final assembly of the battery, e.g., inserted into the respective compartment, in particular independently of the other of the two adjacent cell modules.

In a further possible embodiment of the present invention, the respective protective plate is attached to at least one coolant connection of one of the two adjacent cell modules and/or to at least one coolant line of a cell module cooling system. Such a cell module cooling system can here be a cooling device or a cooling system for cooling one or both of the adjacent cell modules during operation of the respective battery. The attachment of the protective plate provided here can avoid compromising the integrity of the cell modules, since, for example, no fastening hole or screw connection or the like has to be arranged in an outer wall of the cell modules for fastening the protective plate, which could mean a potential weakening of this outer wall.

In addition, the fastening of the protective plate proposed here can prevent the formation of a direct heat conduction path between the interior of the respective cell module and the protective plate by a respective fastening means. As a result, improved thermal decoupling of the protective plate from the cell modules can be achieved. This in turn can avoid or reduce an additional thermal load on the protective plate in the event of a thermal fault and thus increase its service life or resistance time in the event of a thermal fault with a particularly material-saving design. This can also be supported here by the fact that the attachment of the protective plate to the cooling line connection and/or the at least one coolant line enables heat introduced into the protective plate-for example by heated cell ejection hitting the protective plate-to be dissipated in a particularly short and direct way via the cell module cooling, in particular bypassing the cell modules. In this way, the protective effect of the protective plate can be maintained particularly reliably and for a particularly long time in the event of a thermal fault and further propagation of the thermal fault by the cell ejection or the energy transported by it can be further contained in a particularly simple manner.

In a further possible embodiment of the present invention, the respective protective plate is attached, in particular screwed, to a housing base of the battery housing and/or to a housing cover of the battery housing and/or to a module housing of at least one of the two adjacent cell modules. This can enable a particularly stable and robust attachment of the protective plate, so that it can remain in its intended location in a particularly safe and reliable manner even if the battery is stressed or damaged and can develop its thermal and material-inhibiting protective effect there. If the protective plate is attached to the battery housing, it is also possible to avoid compromising the integrity, for example the mechanical stability, tightness and/or heat and/or material containment capacity of the cell modules.

Furthermore, by attaching the protective plate to the battery housing, additional protection against displacement of the cell modules within the storage compartment and thus improved stability or robustness of the battery can be achieved.

Furthermore, such an attachment or connection of the protective plate to the battery housing can dissipate heat from the protective plate to the battery housing. The battery housing can act as a relatively large heat sink or radiator-for example in comparison to the protective plate itself and/or the cell modules-or at least can have a comparatively large heat capacity and thus act as a heat sink for safely absorbing the heat generated in the event of a fault and possibly transferred to the protective plate.

If the protective plate is attached to a module housing of one of the two adjacent cell modules, a corresponding composite of the respective module housing or cell module and the protective plate can then be advantageously prefabricated separately from the battery housing and then handled particularly easily during production or final assembly of the battery, for example inserted into the respective receiving compartment. In addition, it can thus be achieved particularly safely and reliably that the protective plate permanently retains its intended position relative to the cell module to which it is attached and can thus permanently shield the cell module particularly safely from cell ejection or absorb cell ejection from the cell module even in the event of mechanical loads or vibrations of the battery.

The present invention also relates to a motor vehicle equipped with a battery according to the invention. In particular, the battery according to the invention can be a traction battery of the motor vehicle according to the invention. The motor vehicle according to the invention can in particular be the motor vehicle mentioned in conjunction with the battery according to the invention or can correspond thereto. In the application case of a motor vehicle proposed here, the advantages described in conjunction with the battery according to the invention can be particularly relevant and can be brought to bear in a particularly beneficial manner, for example in order to directly improve the safety of vehicle occupants of the motor vehicle and ultimately to enable particularly efficient or energy-saving operation of the motor vehicle.

Further features of the invention may be derived from the claims, the figures and the description of the figures. The features and combinations of features mentioned above in the description as well as the features and combinations of features shown below in the figure description and/or in the figures alone can be used not only in the combination indicated in each case, but also in other combinations or on their own, without departing from the scope of the invention.

### BRIEF DESCRIPTION OF THE DRAWINGS

FIG. 1 is a schematic partial view of a battery with several cell modules protected against fault escalation;

FIG. 2 is a schematic partial perspective view of an interior of a battery with a protective plate for inhibiting particle dispersion; and

FIG. 3 is a schematic partial perspective view of the interior of a battery with a protective plate in an alternative arrangement.

In the figures, identical and functionally identical elements are provided with the same reference signs.

### DETAILED DESCRIPTION OF THE DRAWINGS

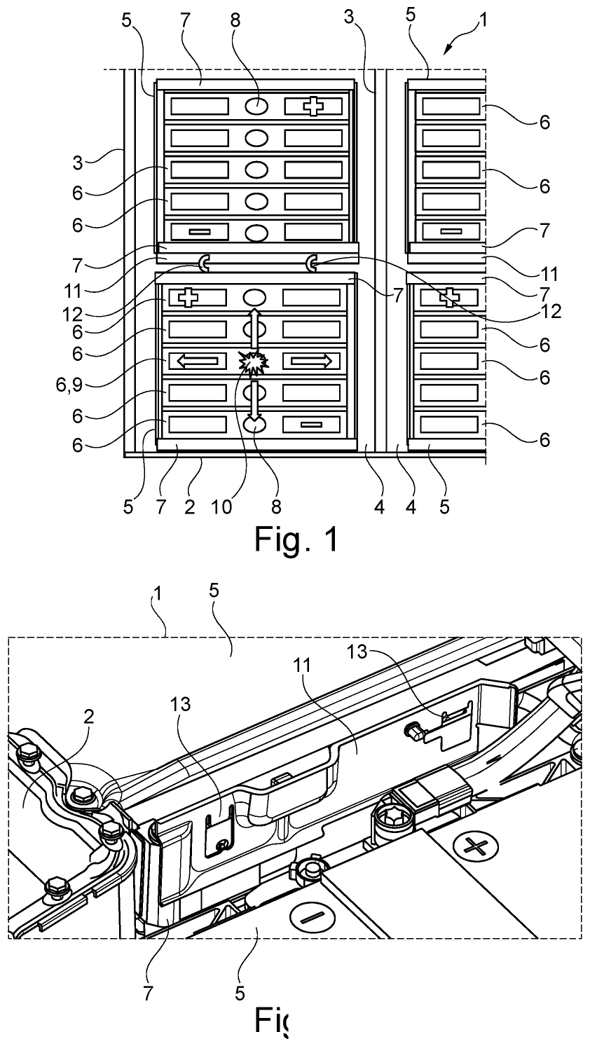

FIG. 1 shows a partial schematic view of a battery 1 with a partially depicted battery housing 2. For mechanical reinforcement, the battery 1 has several struts 3, by which an interior of the battery housing 2 is divided into several compartments 4. Parts of two of these compartments 4 are shown here as examples. At least or exactly two adjacent cell modules 5 are arranged in each of the receiving compartments 4. These cell modules 5 in turn comprise several battery cells 6, of which only a selection is explicitly marked here for the sake of clarity. The battery cells 6 of a cell module 5 are each clamped between external pressure plates 7 of the respective cell module 5.

In the event of a cell defect in the battery 1, particularly if it is a high-voltage storage system and/or a lithium-based cell chemistry is used in it, high temperatures in the range of several 100° C. to over 1000° C. may develop, resulting in the formation of gas. In order to avoid uncontrolled bursting or rupture of one of the battery cells 6 as a result, the battery cells 6 have a respective degassing point 8. An example of such a fault in one of the battery cells 6, referred to as a fault cell 9, is shown here. In the event of a corresponding thermal fault event 10, cell ejection can escape through the degassing point 8 of the fault cell 9, which can, for example, comprise heated gas and/or electrically conductive particles.

Conventionally, this cell ejection could spread within the respective receiving compartment 4 and thus also reach the adjacent cell module 5 and cause consequential damage there.

In order to counter this problem, a protective plate 11 is arranged between the two adjacent cell modules 5 within the respective receiving compartment 4 to contain the spread of cell ejection in the event of a thermal fault in one of the battery cells 6 of one of these two adjacent cell modules 5. The protective plate 11 can be attached to one of the pressure plates 7, for example.

The protective plate 11 can, for example, be designed as a jet protection plate in order to block a particle jet generated by the thermal fault event 10 and thus protect the respective adjacent cell module 5 within the respective receiving compartment 4 from a corresponding particle bombardment or a corresponding particle deposit. Instead, after the thermal fault event 10, an ejection deposit 12 can occur on a side of the protective plate 11 facing the respective fault cell 9. In this way, for example, short circuits or excitation of a thermal runaway in the adjacent cell module 5, in this case on the side of the protective plate 11 facing away from the fault cell 9 within the respective receiving compartment 4, can be avoided or at least made less likely.

There can be several options for the design of the protective plate 11. When selecting a material for the protective plate 11, a high thermal stability can be aimed for in particular. For example, materials such as steel or mica can be used for the protective plate 11, which can retain their mechanical strength even at temperatures of over 1000° C.

For further illustration, FIG. 2 shows a partial schematic perspective view of the battery 1 in an open state, for example without a housing cover. As a result, several cell modules 5 are partially visible here. As an example, the protective plate 11 is attached to one of the cell modules 5 by means of snap connections 13. In particular, steel joining parts or clips can be used to attach the protective plate 11 to the cell module 5, for example to its pressure plate 7.

It can also be seen here that the protective plate 11 does not have to be plate-shaped in the geometrically strict sense, but can, for example, have bends, bulges, recesses, kinked areas and/or the like. In this way, the protective plate 11 can be adapted to an arrangement or a course of other surrounding components of the respective cell module 5 and/or the battery 1, i.e., can follow their overall contour. However, further or other arrangement and/or fastening options for the protective plate 11 are also possible.

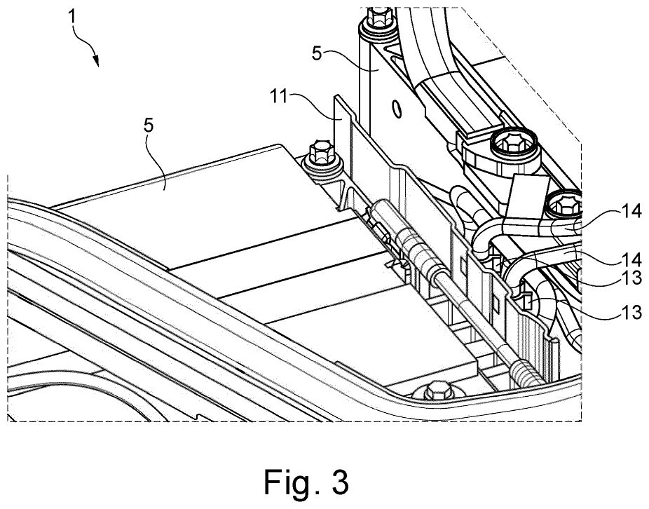

FIG. 3 shows a partial schematic perspective view of the battery or a battery 1 in another possible embodiment. Two cell modules 5 are also partially shown here, between which the protective plate 11 is arranged. The protective plate 11 is attached here—additionally or alternatively—to coolant lines 14 of the battery 1, in particular via elastically deformable snap connections 13, each of which partially surrounds one of the coolant lines 14.

Another alternative or additional option for fastening or connecting the protective plate 11 is, for example, a screw connection of the protective plate 11 to housing components or housing walls of the battery housing 2 and/or to at least one of the two adjacent cell modules 5.

In any case, the fastening means used, such as the snap connections 13 and/or screws or the like—like the protective plate 11 itself—can consist of or be made of a temperature-resistant material, such as steel, in order to keep the protective plate 11 in place, i.e., in its intended installation position, even at temperatures of over 1000° C., as can occur during the thermal fault event 10 within the battery 1.

All in all, the examples described show how a particle jet protection plate for isolating battery modules from one another can be realized and arranged in a common compartment of a corresponding housing, in particular of a high-voltage storage system.

### LIST OF REFERENCE SYMBOLS

1 battery
2 battery housing
3 strut
4 receiving compartment
5 cell module
6 battery cell
7 pressure plate
8 degassing point
9 fault cell
10 thermal fault event
11 protective plate
12 ejection deposit
13 snap connection
14 coolant line

1-10. (canceled)

11. A battery, comprising:
a battery housing, in which several separate receiving compartments are formed by housing walls of the battery housing and by several load-bearing struts extending from one housing wall of the battery housing to an opposite housing wall of the battery housing;
several cell modules arranged in each of the several separate receiving compartments;
a non-load-bearing protective plate, which is different from both the battery housing and a structure of the receiving compartments, is arranged in each case between two cell modules arranged adjacently to one another in one of the receiving compartments,
wherein the non-load-bearing protective plate is configured to contain, in regions, a spreading of a battery cell leakage, in an event of a thermal runaway of a battery cell, from one of the adjacent cell modules to the other.

12. The battery according to claim 11, wherein
the protective plate is arranged so that a main plane of extent is perpendicular to a main direction of extent of the struts delimiting the respective receiving compartment.

13. The battery according to claim 11, wherein
the protective plate is made of sheet steel or a mica material.

14. The battery according to claim 11, wherein
the protective plate is spaced, at least in its main direction of extent, from the struts delimiting the respective receiving compartment.

15. The battery according to claim 11, wherein
the protective plate in its main plane of extent is, at most, as large as side walls of the two adjacent cell modules facing the plate.

16. The battery according to claim 11, wherein
the protective plate is fastened to a steel joining part via a snap connection.

17. The battery according to claim 11, wherein
the two adjacent cell modules each comprise several battery cells and end pressure plates clamping the latter, and
the protective plate is fastened on an outside of such a pressure plate, facing the respective other cell module, of only one of the two cell modules.

18. The battery according to claim 11, wherein
the protective plate is attached to a cooling line connection of one of the two adjacent cell modules and/or to a coolant line of a cell module cooling system.

19. The battery according to claim 11, wherein
the protective plate is fastened to a housing base and/or a housing cover of the battery housing and/or to a module housing of at least one of the two adjacent cell modules.

20. A motor vehicle comprising a battery according to claim 11.

21. The motor vehicle according to claim 20, wherein the battery is a traction battery of the motor vehicle.
